(19) United States
(12) Patent Application Publication
(10) Pub. No.: US 2012/0324218 A1
(43) Pub. Date: Dec. 20, 2012

(54) Peer-to-Peer Trusted Network Using Shared Symmetric Keys

(76) Inventors: Michael J. Duren, Clearwater, FL (US); Rene E. Menard, III, Tampa, FL (US); Jeremy L. Rasmussen, Lutz, FL (US); Keith R. Thal, Lutz, FL (US)

(21) Appl. No.: 13/163,086

(22) Filed: Jun. 17, 2011

(51) Int. Cl. H04L 9/32; H04L 9/08

(52) U.S. Cl. 713/158; 713/162; 713/156

(57) ABSTRACT

A unique, strong, shared, symmetric network-wide key (or a limited number of group-wide keys) is generated by a central authority and initially provisioned to nodes in a network, which use it for ensuing traffic encryption. Nodes establish trust by sending each other authentication messages encrypted with the shared secret key, and thereupon adding each other to their respective trust lists. Also, an optional rekeying scheme whereby an existing shared secret key can be replaced by a new secret key that is introduced by the central authority and automatically propagated from node to node through the network.

### FIELD OF THE INVENTION

The present invention relates to networked systems in general and, in particular, to a peer-to-peer trusted network using shared symmetric keys.

### BACKGROUND

In secure networks where communicating nodes may be great in number (e.g., hundreds, thousands, or more), and/or limited in hardware capabilities (e.g., such as in a sensor network), the standard keying schemes—such as public key infrastructures (PKIs) or central trusted key authorities—may be impractical in terms of speed, processing power, and scalability. Every time two nodes connect to transmit data to each other (each ‘session’) in such schemes, each must first provide its certificate to the other node, and authenticate the other's based on various criteria (e.g., trusted certificate signer list, date, name match, public key decrypts correct message authentication code, etc.); then, using the exchanged certificates, the two nodes must exchange data to be used in producing a session key, which requires significant message traffic. Further complicating matters is the fact that the two nodes contributing to the session key generation may not have access to strong pseudo-random number generators (PRNGs) to ensure the generated key is sufficiently secure. Also, in PKI and the like, certificate authentication involves referencing a typically rapidly-growing (and thus frequently-downloaded) certificate revocation list, or else querying a responder via online certificate status protocol, both of which involve significant out-of-band message traffic.

Also, while the prior art includes methods for rekeying (such as may be desired after the compromise of one or more nodes or keys), they are relatively slow and resource-intensive, which can be particularly problematic in large-scale, diverse, and/or disadvantaged networks.

### SUMMARY

A peer-to-peer trusted network using shared symmetric keys according to the present invention handles keying and trust in a way that is scalable and requires limited processing power and memory to deploy at end nodes, which can permit efficient distribution and management of cryptographic keying material for systems comprising large numbers of small scale, widely-spread, disadvantaged devices with limited communications bandwidth. A unique, strong, shared, symmetric network-wide key (or a limited number of group-wide keys) is generated by a central authority and initially provisioned to the nodes, which use it for all ensuing traffic encryption, resulting in increasing performance throughput and reducing network bandwidth need compared to schemes employing one time use session encryption keys. Trust is established between nodes by sending each other authentication messages encrypted with the shared secret key, and thereupon adding each other to their respective trust lists. Although sharing a secret among multiple members theoretically increases security risk, network bandwidth and hardware requirements are reduced by the elimination of redundant trust establishment, the scheme can permit frequent, ad-hoc, incremental additions or upgrades of nodes in a network without significant (if any) downtime, and it can enhance network availability by permitting operation around a failed member.

In a separate and independent aspect of the invention, a rekeying scheme optionally can be implemented whereby an existing shared secret key can be replaced by a new secret key that is introduced by the central authority and automatically propagated from node to node through the network. The scheme can allow rapid, low-overhead rekeying, and can facilitate quicker recovery of functionality after the compromise of one or more nodes or keys.

### BRIEF DESCRIPTION OF THE DRAWINGS

FIG. 1 depicts a key distribution scheme startup sequence, or initial provisioning, of a new node in a network according to an embodiment of the present invention.

FIG. 2 depicts the process of establishing trust between a new node and established nodes in a network according to an embodiment of the present invention.

FIG. 3 depicts a method of providing nodes with new keys according to an embodiment of a separate feature of the present invention.

### DETAILED DESCRIPTION OF A PREFERRED EMBODIMENT

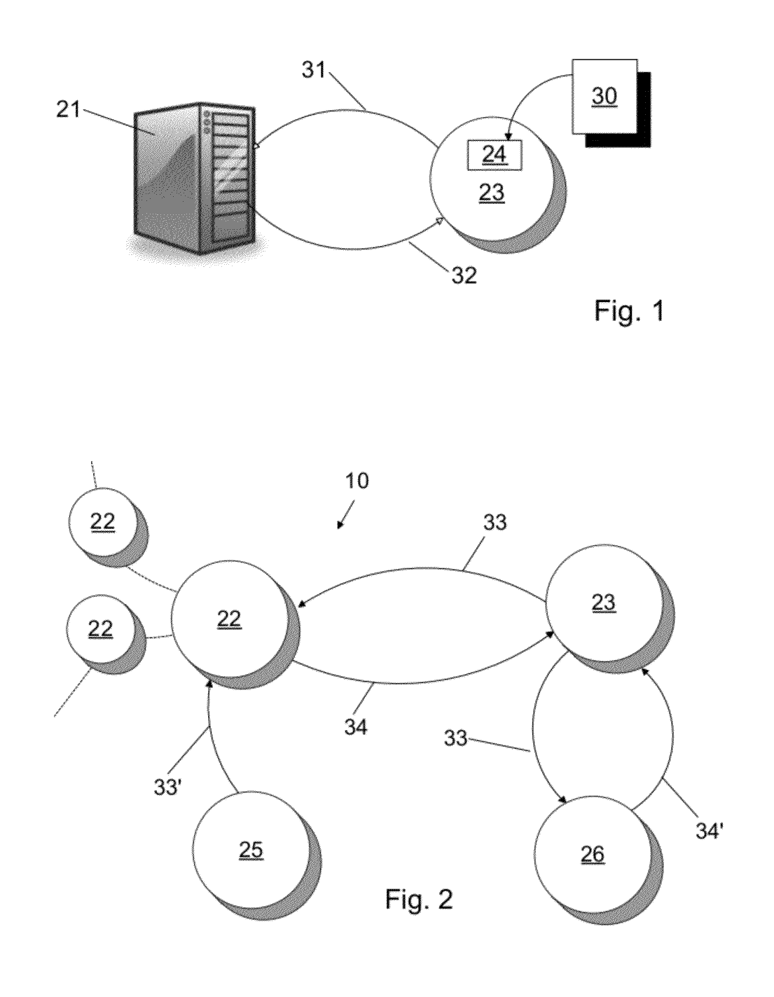

FIG. 1 depicts a key distribution scheme startup sequence, or initial provisioning, in an embodiment of a network according to the present invention. A trusted manufacturing agent or licensing system 30 installs a license file 24 and software on a new node 23, which then uses information from the license file 24 as part of a seed to generate a certificate including a public key (e.g., per the X.509 v.3 standard) and to generate a corresponding private key (which key never leaves the new node 23). The new node 23 provides a signed request for a shared symmetric secret key, signed with its private key. The new node 23 can send this request while directly connected to the central authority 21 (e.g., via an out-of-band connection such as telephone line), or alternatively the new node 23 could send the request to the central authority 21 while remotely connected to it via established nodes. (In the latter case, i.e., networked initial provisioning, the request would further include the destination IP address of the central authority 21 and the sending new node 23's IP address, and established nodes would permit passage of such requests for the shared secret key that are not encrypted with the shared secret key). In either case, the central authority 21 validates the signature of the request using the new node 23's certificate (which is conveyed to the central authority 21 by the trusted manufacturing agent or licensing system 30 upon licensing of the new node 23) and validates the certificate against a database of valid license files. Once the central authority 21 has authenticated the new node 23, it adds the node's information to a ‘whitelist’ of valid IP address/public key pairs that it maintains, and conveys to the new node 23 a shared secret key 32 (and its current whitelist) that is encrypted using that node's public key. The new node 23 then uses its private key to decrypt the received shared secret key 32. The shared secret key 32 is strong, has a significant number of bits for entropy, has attributes of an identifier, and is associated with an effective time. The nodes preferably store their certificates, shared secret key, and lists in protected, non-volatile memory. (The nodes preferably each have their own ‘trust list,’ the contents of which are replaced by the contents of a whitelist whenever one is received from the central authority 23).

Optionally, a network (e.g., a public utility electrical power grid) can be divided into groups (not shown) that each have their own respective shared secret key, for example to compartmentalize a diverse network by function, geography, security, etc.

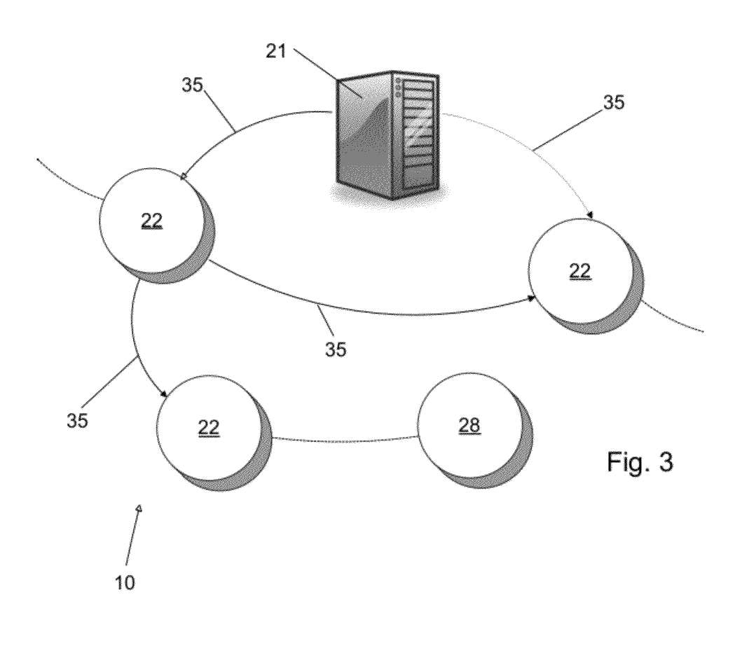

As shown in FIG. 2, after a new node 23 has been provisioned and contains a certificate and the shared secret key 32, it then establishes trust with other nodes in the network 10 by broadcasting an establishment request message 33, which is encrypted using the shared secret key 32 and contains the new node 23's IP address, public key, random data, and a hash value. An established node 22 receiving the establishment request message 33 decrypts it using the shared secret key 32 and validates a message digest. Upon validation, the established node 22 adds the new node 23 to its trust list (if not already present therein), and sends the new node 23 an establishment accepted message 34, likewise encrypted using the shared secret key 32 and containing the established node 22's IP address, public key, random data, and a hash value. The new node 23 then decrypts the received establishment accepted message 34 and upon validation, adds the established node 22 to its trust list (if not already present therein).

If an imposter node 25 attempts to establish trust with the network 10 by acting as a new node broadcasting an establishment request message 33′ not encrypted with the shared secret key 32, an established node 22 receiving that message will not be able to decrypt it using the shared secret key 32, will log the event, and will not add the imposter node 25 to its trust list or send the imposter node 25 an establishment accepted message. If an imposter node 26 attempting to act as an established node receives a new node 23's establishment request message 33, it will not be able to decrypt the message's contents since it does not possess the shared secret key 32; conversely, if the imposter node 26 sends an establishment accepted message 34′ to the new node 23, the new node 23 will not be able to decrypt the message because it was not encrypted with the shared secret key 32, and will log the event and not add the imposter node 26 to its trust list.

FIG. 3 depicts a rekeying method, which could for example be done periodically on a planned basis, and/or on an ad hoc basis such as if one or more nodes expire or become compromised (in which case their credentials are revoked) or the grouping of members in a grouped network is to be changed. Rather than communicating with each node, the central authority instead initiates rekeying by communicating with as few as just one established node (at least one node per group being rekeyed) to propagate the new shared secret key and a current whitelist of trusted nodes through the rest of the network. The central authority 21 thus sends one or more rekey messages 35 (encrypted with the public key of the specific nodes to which the rekey messages 35 are sent—two are shown for illustration, but as noted this could be just one) containing the new shared secret key along with an effective time and current whitelist. The recipient established nodes 22 decrypt the rekey message 35 using their private keys, validate its contents, store the new shared secret key, and preferably also return an encrypted verification message to the central authority 21. Each then preferably logs any differences between the prior and new whitelists, and sends rekey messages 35 to the still-whitelisted established nodes 22 to which they are connected, encrypted with the public keys of the respective recipient nodes. (Redundant received rekey messages 35 can be disregarded, or else each node could maintain a list of which other nodes have already been rekeyed, and then would not propagate keys to them, reducing the number of redundant messages and thus bandwidth required during rekey). Established nodes 22 will not send a rekey message 35 to any suspect or expired nodes 28 to which they are connected (shown by dashed line) but are not on the new whitelist. At the specified effective time, all established nodes 22 that received the rekey message 35 rollover to the new shared secret key, and those that did not will no longer be trusted by the network 10.

The rekeying method also could be extended to effect network management. For example, in accordance with a given threat scenario, such as a denial of service attack, the central authority could issue a priority list of nodes (by groups of nodes or even down to a single node) whose data is critical to be passed for the given threat level.

One skilled in the art will appreciate that other variations, modifications, and applications are also within the scope of the present invention. Thus, the foregoing detailed description is not intended to limit the invention in any way, which is limited only by the following claims and their legal equivalents.

What is claimed is:

1. A method of establishing trust between nodes in a network comprising the following steps:
a. provisioning a plurality of nodes in the network with a shared secret key;
b. connecting together a plurality of nodes in the network each having said shared secret key;
c. causing a first of said plurality of nodes of step b to issue, to a second of said nodes of step b, an establishment request message encrypted with said shared secret key and containing identification of said first node;
d. causing said second node to decrypt said establishment request message with said shared secret key and validating its contents;
e. upon validating said establishment request message, causing said second node to add said first node to a trusted node list maintained by said second node if said first node is not present in that list;
f. causing said second node to issue, to said first node, an establishment accepted message encrypted with said shared secret key and containing identification of said second node;
g. causing said first node to decrypt said establishment accepted message with said shared secret key and validating its contents; and
h. upon validating said establishment accepted message, causing said first node to add said second node to a trusted node list maintained by said first node if said second node is not present in that list.

2. The method of claim 1, wherein said establishment request message further contains a key specific to said first node, and said establishment accepted message further contains a key specific to said second node.

3. The method of claim 1, further comprising the step of causing a central authority to generate said shared secret key.

4. The method of claim 3, wherein the step of providing nodes with a shared secret key includes the following steps:
a. causing one or more nodes to send respective node information to said central authority;
b. causing said central authority to check the validity of node information received from each of said one or more nodes; and
c. causing said central authority to issue said shared secret key to each node upon validating that node's information.

5. The method of claim 4, wherein said node information includes credentials and license information.

6. The method of claim 4, wherein the steps of sending node information, checking validity of node information, and issuing said shared secret key are carried out multiple times, such that new nodes or groups of new nodes are added to the network at different times.

7. The method of claim 4, further comprising the step of said central authority issuing a whitelist of currently trusted nodes to a node upon validating that node's information.

8. The method of claim 7, wherein any node that receives a whitelist from said central authority replaces the contents of its trusted node list with the contents of the received whitelist.

9. The method of claim 7, wherein nodes include a protected non-volatile memory in which said shared secret key and said trusted node list are stored.

10. The method of claim 1, wherein nodes include a protected non-volatile memory in which said shared secret key and said trusted node list are stored.

11. A method of replacing an existing shared secret key in a network including a central authority and a plurality of nodes, comprising the following steps:
a. causing the central authority to generate a shared secret key that is strong and unique;
b. issuing from the central authority, directly to at least one node in the network, a rekey message containing said new shared secret key, and a whitelist of currently trusted nodes;
c. propagating a rekey message from at least one node to one or more nodes that are connected thereto and listed in said whitelist; and
d. causing all nodes in the network that receive a rekey message to replace the existing shared secret key with said new shared secret key.

12. The method of claim 11, further comprising repeating step c.

13. The method of claim 11, further comprising repeating step c until all connected nodes listed in said whitelist have received a rekey message.

14. The method of claim 11, wherein said rekey message of step b also contains an effective time for said new shared secret key.

15. The method of claim 14, wherein step d occurs upon said effective time.

16. The method of claim 11, wherein said direct issuance of a rekey message by the central authority in step b is to no more than one node in the network.

17. The method of claim 11, wherein each node in the network includes its own internally-stored trusted node list, and the method further comprises the step of causing all nodes in the network that receive a rekey message to replace the contents of their respective trusted node lists with the contents of the whitelist contained in the rekey message.

18. The method of claim 11, wherein each node in the network includes its own trusted node list, and each node stores said trusted node list and said shared secret key in protected, non-volatile memory.

19. The method of claim 11, wherein said whitelist includes addresses corresponding to the nodes listed therein.

20. The method of claim 11, wherein said whitelist lists one group of nodes in the network rather than all nodes in the network.
